(19) United States
(12) Patent Application Publication
(10) Pub. No.: US 2007/0234831 A1
(43) Pub. Date: Oct. 11, 2007

(54) Rotary button device

(76) Inventor: Ching-Hsiang Wang, Tainan City (TW)

Correspondence Address: Ching-Hsiang Wang, P.O. BOX 90, Tainan City, 70499, TW

(21) Appl. No.: 11/392,783

(22) Filed: Mar. 30, 2006

(51) Int. Cl. F16H 35/18

(52) U.S. Cl. 74/10 R

(57) ABSTRACT

A rotary button device comprises a panel having a receiving room; the receiving room having a flange; the flange being installed with a stop; a rotary shaft protruding from a center portion of the receiving room; a positioning rod transversally passing through the rotary shaft; a button installed in the receiving room; a post protruding from the button; the post having an insertion hole for receiving the rotary shaft and the positioning rod of the panel; a lower side of the button being installed with a block; and a metal ring being installed on the post of the button. The metal ring has a shape identical to that of the post.

### FIELD OF THE INVENTION

The present invention relates to buttons, and in particular to a rotary button device which can prevent the button to break and is positioned in a rotary range so as to increase the lifetime.

### BACKGROUND OF THE INVENTION

In the prior art, referring to FIG. 1. A panel 1 has a receiving room 10. The receiving room 10 has a flange 11 therein. A rotary shaft 12 protrudes from a center portion of the receiving room 10. A positioning rod 13 transversally passes through the rotary shaft 12. A button 2 is installed in the receiving room 10 of the panel 1. A post 20 protrudes from the button 2. The post 20 is formed with an insertion hole 21 for receiving the rotary shaft 12 and the positioning rod 13. Therefore, the button 2 can be assembled to the panel 1. However the button 2 is made of plastics. If a great force is applied thereto, the post 20 of the rotary shaft 12 will be destroyed and thus the button 2 cannot be used. Thus the lifetime of the button 2 is short and the rotary range of the button 2 cannot be determined. It is often that the over rotation will cause the elements in the panel 1 to be destroyed.

### SUMMARY OF THE INVENTION

Accordingly, the primary object of the present invention is to provide a rotary button device which can prevent the button to break and is positioned in a rotary range so as to increase the lifetime.

To achieve above objects, the present invention provides a rotary button device which comprises a panel having a receiving room; the receiving room having a flange; the flange being installed with a stop; a rotary shaft protruding from a center portion of the receiving room; a positioning rod transversally passing through the rotary shaft; a button installed in the receiving room; a post protruding from the button; the post having an insertion hole for receiving the rotary shaft and the positioning rod of the panel; a lower side of the button being installed with a block; a metal ring being installed on the post of the button. The metal ring has a shape identical to that of the post.

The various objects and advantages of the present invention will be more readily understood from the following detailed description when read in conjunction with the appended drawing.

### BRIEF DESCRIPTION OF THE DRAWINGS

FIG. 1 is an exploded perspective view of the prior art.

FIG. 2 is an exploded perspective view of the present invention.

FIG. 3 is a cross sectional view of the rotary shaft of the present invention.

FIG. 4 is a plane schematic view of the present invention.

FIG. 5 is a schematic view showing the rotation of the button of the present invention.

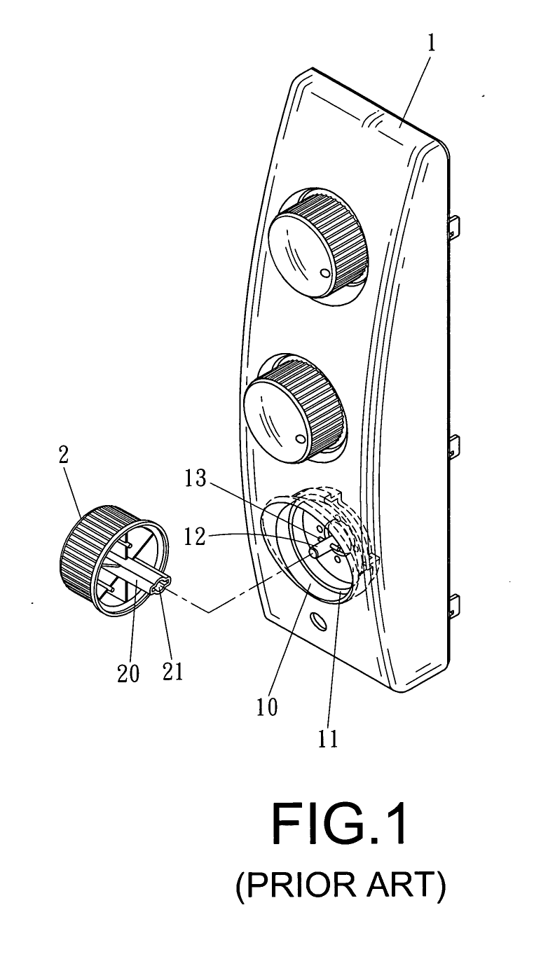

### DETAILED DESCRIPTION OF THE INVENTION

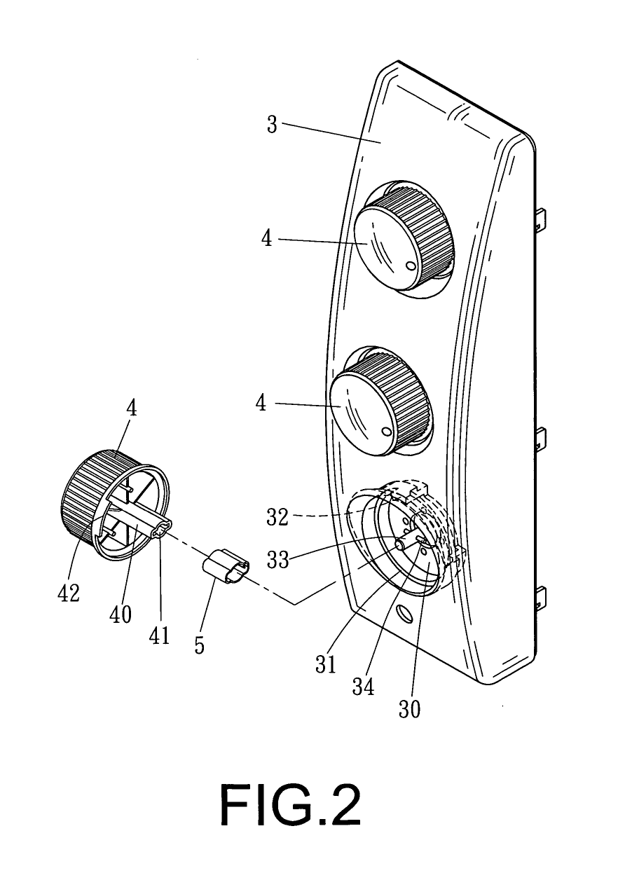

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIG. 2, the present invention is illustrated. The present invention has the following elements.

A panel 3 has a receiving room 30. The receiving room 30 has a flange 31. The flange 31 is installed with a stop 42. A rotary shaft 33 protrudes from a center portion of the receiving room 30. A positioning rod transversally passes through the rotary shaft 33. A button 4 is installed in the receiving room 30. The button 4 is made of plastics. A post 40 protrudes from the button 4. The post 40 has an insertion hole 41 for receiving the rotary shaft 33 and the positioning rod 34 of the panel 3. A lower side of the button 4 is installed with a block 42. A metal ring 5 is installed on the post 40 of the button 4. The metal ring 5 has a shape identical to that of the post 40.

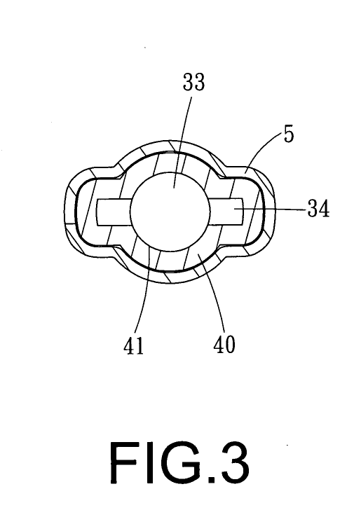

Referring to FIGS. 2 to 4, the assembly of the present invention will be described herein. Firstly, the metal ring 5 encloses the post 40. Then the button 4 is assembled to the receiving room 30 of the panel 3 so that the rotary shaft 33 and the positioning rod 34 inserts into the insertion hole 41 of the post 40 of the button 4. The block 42 of the button 4 is positioned on the flange 31 of the receiving room 30. Thus the button 4 is assembled to the panel 3.

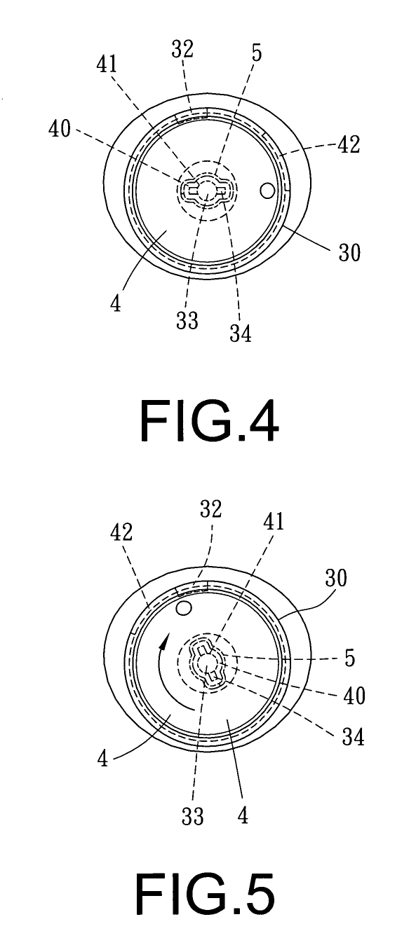

In use, referring to FIGS. 4, 5, when the button 4 rotates, the post 40 of the button 4 is enclosed by the metal ring 5 for increasing the strength of the post 40 to prevent the post 40 to break due to a great twisting force. Thus the lifetime of the button 4 is increased. When the block 42 of the button 4 is rotated to be in front of the stop 32 in the receiving room 30, it will be stopped by the stop 32 and thus cannot rotate further. Thereby the rotation range of the button 4 is confined without over-rotation to destroy the internal elements of the button 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rotary button device comprising:
a panel having a receiving room; the receiving room having a flange; the flange being installed with a stop;
a rotary shaft protruding from a center portion of the receiving room; a positioning rod transversally passing through the rotary shaft;
a button installed in the receiving room; a post protruding from the button; the post having an insertion hole for receiving the rotary shaft and the positioning rod of the panel; a lower side of the button being installed with a block; and a metal ring being installed on the post of the button.

2. The rotary button device as claimed in claim 1, wherein the metal ring has a shape identical to that of the post.
